(19) United States
(12) Patent Application Publication
(10) Pub. No.: US 2013/0044062 A1
(43) Pub. Date: Feb. 21, 2013

(54) METHOD AND APPARATUS FOR TRANSLATING BETWEEN FORCE INPUTS AND TEMPORAL INPUTS

(71) Applicants: Raja Bose, Mountain View, CA (US); Jörg Brakensiek, Mountain View, CA (US)

(72) Inventors: Raja Bose, Mountain View, CA (US); Jörg Brakensiek, Mountain View, CA (US)

(73) Assignee: NOKIA CORPORATION, Espoo (FI)

(21) Appl. No.: 13/211,060

(22) Filed: Aug. 16, 2011

(51) Int. Cl. G06F 3/041

(52) U.S. Cl. 345/173

(57) ABSTRACT

An apparatus, method, and computer program product are described that provide for translating between force inputs and temporal inputs to execute operations conventionally associated with temporal inputs. The apparatus includes at least one processor and at least one memory including computer program code that are designed to cause the apparatus to at least receive a force indication relating to a force component of the input received, and provide for execution of an operation associated with a temporal input based on the force indication. For example, an input having a force component, such as a “hard press,” would result in the execution of an operation otherwise associated with a temporal input, such as a “long press.” By using a force input, the user can effect an operation in less time by cutting out the time that would have been expended to execute the corresponding “long press” gesture.

### TECHNOLOGICAL FIELD

Embodiments of the present invention relate generally to providing for execution of operations conventionally associated with a temporal input in response to an input having a force component. In particular, embodiments of the present invention relate to an apparatus and method for translating between user inputs having force components and user inputs having temporal components in mobile terminals.

### BACKGROUND

Users of mobile devices are constantly seeking faster, more efficient ways to access information and perform operations on their devices. Some devices are equipped to receive user inputs, such as via a touch screen display, that involve a force component (e.g., an input that involves a certain amount of force applied by the user's finger) and/or a temporal component (e.g., an input that requires the user to maintain contact with the touch screen display for a certain amount of time to effect a particular function).

Accordingly, it may be desirable to provide an improved mechanism by which a device may receive inputs from the user including force components and/or temporal components and provide for execution of operations based on one or both inputs in an efficient manner.

### BRIEF SUMMARY OF EXAMPLE EMBODIMENTS

Accordingly, embodiments of an apparatus, method, and computer program product are described that provide for the translation between inputs including force components (e.g., force inputs) and inputs including temporal components (e.g., temporal inputs) to execute operations associated with temporal inputs. Embodiments of an apparatus for providing for the translation between force inputs and temporal inputs may include at least one processor and at least one memory including computer program code. The at least one memory and the computer program code may be configured to, with the processor, cause the apparatus to at least receive an input via a touch screen display of the apparatus, receive a force indication relating to a force component of the input received, and provide for execution of an operation associated with a temporal input based, at least in part, on the force indication.

In some cases, the memory and computer program code may be configured to, with the processor, cause the apparatus to determine the temporal input based, at least in part, on the force indication, where the temporal input corresponds to the force component of the input received. The memory and computer program code may also be configured to, with the processor, cause the apparatus to determine the temporal input by determining whether the force component exceeds a predetermined threshold force value. The memory and computer program code may be configured to, with the processor, cause the apparatus to provide for execution of an operation associated with a long press gesture based, at least in part, on the force indication. Similarly, the memory and computer program code may be configured to, with the processor, cause the apparatus to provide for execution of an operation associated with a short press gesture based, at least in part, on the force indication.

In some embodiments, the memory and computer program code may be further configured to, with the processor, cause the apparatus to determine a location of the input received on the touch screen display of the apparatus, where execution of the operation associated with the temporal input is at least partly based on the location of the input. In addition, the memory and computer program code may be further configured to, with the processor, cause the apparatus to receive a temporal indication relating to a temporal component of the input received and to provide for execution of the operation associated with the temporal input based on at least one of the force indication or the temporal indication.

In other embodiments, a method and a computer program product are provided for translating between force inputs and temporal inputs. The method may include receiving an input via a touch screen display of an apparatus; receiving a force indication relating to a force component of the input received; and providing for execution, via a processor, of an operation associated with a temporal input based, at least in part, on the force indication.

In some cases, the temporal input may be determined via a processor based, at least in part, on the force indication, where the temporal input corresponds to the force component of the input received. Determining the temporal input may comprise determining whether the force component exceeds a predetermined threshold force value. Furthermore, providing for execution of an operation associated with the temporal input may comprise providing for execution of an operation associated with a long press gesture based, at least in part, on the force indication and/or providing for execution of an operation associated with a short press gesture based, at least in part, on the force indication.

In some embodiments, a location of the input received on the touch screen display of the apparatus may be determined, and execution of the operation associated with the temporal input may be at least partly based on the location of the input. In addition, a temporal indication may be received relating to a temporal component of the input received, and execution of the operation associated with the temporal input may be provided for based on at least one of the force indication or the temporal indication.

In still other embodiments, a method is provided for translating between force inputs and temporal inputs, in which operations associated with temporal inputs to a touch screen display are identified and a force input corresponding to each temporal input is determined. In addition, each temporal input may be associated with a respective corresponding force input, such that receipt of a particular force input at the touch screen display results in the execution of an operation associated with the corresponding temporal input. The temporal inputs and the corresponding force inputs may be associated via a lookup table, and/or each temporal input may be associated with a respective corresponding force input via a function call.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one example of a communication system according to an example embodiment of the present invention;

FIG. 2 illustrates a schematic block diagram of an apparatus for translating between force inputs and temporal inputs according to an example embodiment of the present invention;

FIG. 3 illustrates an apparatus configured to translate between force inputs and temporal inputs according to an example embodiment of the present invention;

FIG. 4 shows the apparatus of FIG. 3 with a portion of the touch screen display removed to show force sensors in accordance with an example embodiment of the present invention; and

FIGS. 5-6 illustrate flowcharts of methods of translating between force inputs and temporal inputs in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

Modern mobile terminals are equipped to receive different types of inputs from users. Mobile terminals are available that include touch screen displays (e.g., capacitive touch screens) that are configured to receive inputs from users in the form of a touch gesture. These touch gestures may include various components of input. For example, a “short press” gesture may include a position component (e.g., the location of the contact); a “swipe” gesture may include a position component and a directional component (e.g., the direction of the movement); a “long press” gesture may include a position component and a temporal component (e.g., the duration of the contact); and a “hard press” gesture may include a position component and a force component (e.g., the amount of force applied due to the contact).

In some cases, a particular mobile terminal may be equipped to receive, interpret, and execute operations based on the different components of input in the form of a touch gesture. For example, some touch screen displays may include a layer of one or more force sensors beneath the touch screen display that are configured to measure the amount of force applied by the user's finger during a touch gesture. In such cases, an operation may be executed based (at least in part) on the force component of the input. Other touch screen displays, however, may not be equipped to receive or interpret a force component of an input (e.g., due to a lack of force sensors). Thus, these types of devices would not be configured to execute an operation based on the force component of an input.

At the same time, users are always looking for ways to streamline interactions with their mobile terminals. For example, users may want to perform functions or display information on their devices in as short amount of time and with as little interaction with the device as possible. This may be due to a preference for convenience, safety (e.g., when the user's prolonged interaction with the device may interfere with other activities, such as driving), or efficiency. Thus, the execution of operations associated with a temporal component of an input, such as operations associated with a “long press” input, may be frustrating to those who would prefer to execute the same operation without having to maintain contact with the touch screen display for a prolonged amount of time (e.g., three seconds).

Accordingly, embodiments of the apparatus, method, and computer program product described below provide for translating between inputs including force components (e.g., force inputs) and inputs including temporal components (e.g., temporal inputs) to execute operations associated with temporal inputs, as described in greater detail below. For example, in some embodiments, devices and methods are provided that are configured to receive an input from a user having a force component, such as a “hard press” gesture, and provide for execution of an operation otherwise associated with a temporal input, such as an operation associated with a “long press” gesture. In this way, the same operation that is conventionally performed when the “long press” gesture is received can be performed as a result of the “hard press” gesture. As a result, the user can effect the same operation in less time by cutting out the extra time that would have otherwise been expended to execute the “long press” gesture (e.g., three seconds as compared to one second).

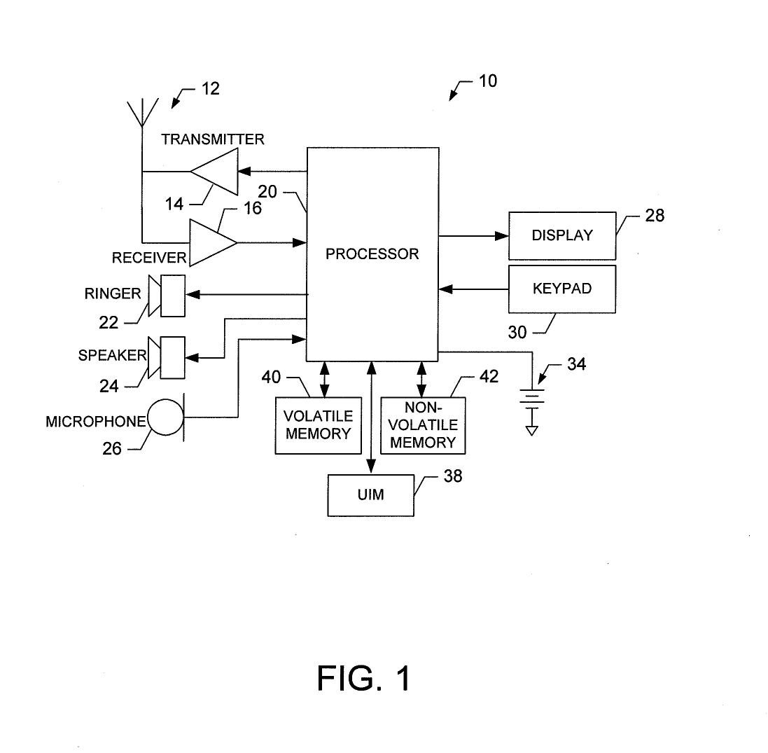

FIG. 1, which provides one example embodiment, illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

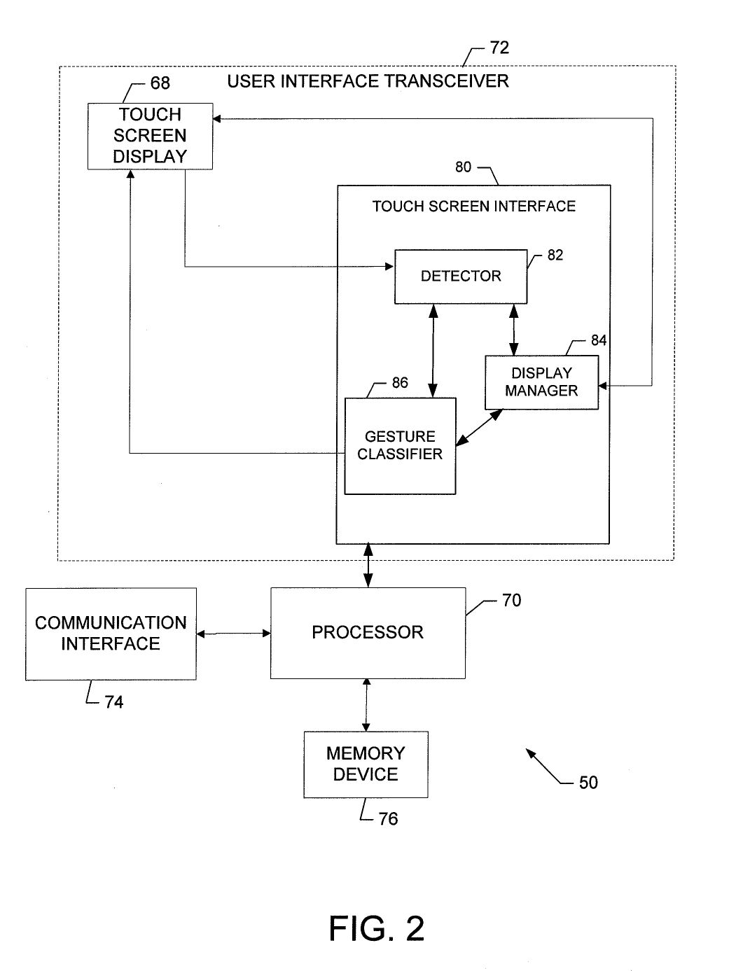

The mobile terminal 10 may include an antenna 12 (or multiple antennas) in operable communication with a transmitter 14 and a receiver 16. The mobile terminal 10 may further include an apparatus, such as a processor 20 or other processing device (e.g., processor 70 of FIG. 2), which controls the provision of signals to and the receipt of signals from the transmitter 14 and receiver 16, respectively. The signals may include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the processor 20 may include circuitry desirable for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 may additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch screen display (display 28 providing an example of such a touch screen display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch screen display, as described further below, may omit the keypad 30 and any or all of the speaker 24, ringer 22, and microphone 26 entirely. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

In some embodiments, the mobile terminal 10 may also include a camera or other media capturing element (not shown) in order to capture images or video of objects, people and places proximate to the user of the mobile terminal 10. However, the mobile terminal 10 (or even some other fixed terminal) may also practice example embodiments in connection with images or video content (among other types of content) that are produced or generated elsewhere, but are available for consumption at the mobile terminal 10 (or fixed terminal).

An example embodiment of the invention will now be described with reference to FIG. 2, in which certain elements of an apparatus 50 for translating between inputs including force components and inputs including temporal components to execute operations associated with temporal inputs are depicted. The apparatus 50 of FIG. 2 may be employed, for example, in conjunction with the mobile terminal 10 of FIG. 1. However, it should be noted that the apparatus 50 of FIG. 2 may also be employed in connection with a variety of other devices, both mobile and fixed, and therefore, embodiments of the present invention should not be limited to application on devices such as the mobile terminal 10 of FIG. 1. For example, the apparatus 50 may be employed on a personal computer or other user terminal. Moreover, in some cases, the apparatus 50 may be on a fixed device such as server or other service platform and the content may be presented (e.g., via a server/client relationship) on a remote device such as a user terminal (e.g., the mobile terminal 10) based on processing that occurs at the fixed device.

It should also be noted that while FIG. 2 illustrates one example of a configuration of an apparatus for translating between force inputs and temporal inputs, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 2, the apparatus 50 for translating between inputs including force components and inputs including temporal components to execute operations associated with temporal inputs may include or otherwise be in communication with a processor 70, a user interface transceiver 72, a communication interface 74, and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, content, applications, instructions, or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. Additionally or alternatively, the communication interface 74 may include the circuitry for interacting with the antenna(s) to cause transmission of signals via the antenna(s) or to handle receipt of signals received via the antenna(s). In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface transceiver 72 may be in communication with the processor 70 to receive an indication of a user input and/or to cause provision of an audible, visual, mechanical or other output to the user. As such, the user interface transceiver 72 may include, for example, a keyboard, a mouse, a joystick, a display, a touch screen(s), touch areas, soft keys, a microphone, a speaker, or other input/output mechanisms. Alternatively or additionally, the processor 70 may comprise user interface circuitry configured to control at least some functions of one or more user interface elements such as, for example, a speaker, ringer, microphone, display, and/or the like. The processor 70 and/or user interface circuitry comprising the processor 70 may be configured to control one or more functions of one or more user interface elements through computer program instructions (e.g., software and/or firmware) stored on a memory accessible to the processor 70 (e.g., memory device 76, and/or the like).

In an example embodiment, the apparatus 50 may include or otherwise be in communication with a touch screen display 68 (e.g., the display 28). In different example cases, the touch screen display 68 may be a two dimensional (2D) or three dimensional (3D) display. The touch screen display 68 may be embodied as any known touch screen display. Thus, for example, the touch screen display 68 could be configured to enable touch recognition by any suitable technique, such as resistive, capacitive, infrared, strain gauge, surface wave, optical imaging, dispersive signal technology, acoustic pulse recognition, and/or other techniques. The user interface transceiver 72 may be in communication with the touch screen display 68 to receive indications of user inputs at the touch screen display 68 and to modify a response to such indications based on corresponding user actions that may be inferred or otherwise determined responsive to the indications.

In an example embodiment, the apparatus 50 may include a touch screen interface 80. The touch screen interface 80 may, in some instances, be a portion of the user interface transceiver 72. However, in some alternative embodiments, the touch screen interface 80 may be embodied as the processor 70 or may be a separate entity controlled by the processor 70. As such, in some embodiments, the processor 70 may be said to cause, direct or control the execution or occurrence of the various functions attributed to the touch screen interface 80 (and any components of the touch screen interface 80) as described herein. The touch screen interface 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the touch screen interface 80 as described herein. Thus, in examples in which software is employed, a device or circuitry (e.g., the processor 70 in one example) executing the software forms the structure associated with such means.

The touch screen interface 80 may be configured to receive an input in the form of a touch event at the touch screen display 68. As such, the touch screen interface 80 may be in communication with the touch screen display 68 to receive user inputs at the touch screen display 68 and to modify a response to such inputs based on corresponding user actions that may be inferred or otherwise determined responsive to the indications. Following recognition of a touch event, the touch screen interface 80 may be configured to determine a classification of the touch event and provide a corresponding function based on the touch event in some situations.

In some embodiments, the touch screen interface 80 may include a detector 82, a display manager 84, and a gesture classifier 86. Each of the detector 82, the display manager 84, and the gesture classifier 86 may be any device or means embodied in either hardware or a combination of hardware and software configured to perform the corresponding functions associated with the detector 82, the display manager 84, and the gesture classifier 86, respectively, as described herein. In an exemplary embodiment, each of the detector 82, the display manager 84, and the gesture classifier 86 may be controlled by or otherwise embodied as the processor 70.

The detector 82 may be in communication with the touch screen display 68 to receive indications of user inputs in order to recognize and/or determine a touch event based on each input received at the detector 82. A touch event may be defined as a detection of an object, such as a stylus, finger, pen, pencil or any other pointing device, coming into contact with a portion of the touch screen display in a manner sufficient to register as a touch. In this regard, for example, a touch event could be a detection of pressure on the screen of the touch screen display 68 above a particular pressure threshold over a given area. Subsequent to each touch event, the detector 82 may be further configured to pass along the data corresponding to the touch event (e.g., location of touch, length of touch, number of objects touching, touch pressure, speed of movement, direction of movement, length of delay, frequency of touch, etc.) to the gesture classifier 86 for gesture classification. As such, the detector 82 may include or be in communication with one or more force sensors configured to measure the amount of touch pressure (e.g., force over a given area) applied as a result of a touch event, as an example.

The gesture classifier 86 may be configured to recognize and/or determine a corresponding classification of a touch event. In other words, the gesture classifier 86 may be configured to perform gesture classification to classify the touch event as any of a number of possible gestures. Some examples of recognizable gestures may include a touch, multi-touch, stroke, character, symbol, shape, swipe, pinch event (e.g., a pinch in or pinch out), and/or the like.

A touch may be defined as a touch event that impacts a single area (without or with minimal movement on the surface of the touch screen display 68) and then is removed. A multi-touch may be defined as multiple touch events sensed at the same time (or nearly the same time). A stroke event may be defined as a touch event followed immediately by motion of the object initiating the touch event while the object remains in contact with the touch screen display 68. In other words, the stroke event may be defined by motion following a touch event thereby forming a continuous, moving touch event defining a moving series of instantaneous touch positions (e.g., as a drag operation or as a flick operation). Multiple strokes and/or touches may be used to define a particular shape or sequence of shapes to define a character. A pinch event may be classified as either a pinch out or a pinch in (hereinafter referred to simply as a pinch). A pinch may be defined as a multi-touch, where the touch events causing the multi-touch are spaced apart. After initial occurrence of the multi-touch event involving at least two objects, one or more of the objects may move substantially toward each other to simulate a pinch. Meanwhile, a pinch out may be defined as a multi-touch, where the touch events causing the multi-touch are relatively close together, followed by movement of the objects initiating the multi-touch substantially away from each other. In some cases, the objects on a pinch out may be so close together initially that they may be interpreted as a single touch, rather than a multi-touch, which then is modified by movement of two objects away from each other.

In some cases, the gesture may include a force component, a temporal component, or both a force component and a temporal component. A force component may be detected, for example, when the force applied in the process of executing a gesture exceeds a predetermined level of force. For example, a “hard press” gesture may be a touch event that includes a force component, whereas a “soft press” gesture may be a touch event that does not include a force component. In other words, a “hard press” gesture may involve some amount of force purposefully applied by the user, whereas a “soft press” gesture may only involve a nominal level of force that is required to allow the detector 82 to detect that a touch event has occurred.

Similarly, a temporal component may be detected, for example, when the duration of the gesture (e.g., the length of time between the initial contact of the user's finger with the touch screen display and separation from the touch screen display) exceeds a predetermined amount of time. For example, a “long press” gesture may be a touch event that includes a temporal component, whereas a “short press” gesture may be a touch event that does not include a temporal component. In other words, a “long press” gesture may involve some amount of time during which the user's finger purposefully maintains contact with the touch screen display, whereas a “short press” gesture may only involve a nominal amount of time during which contact is maintained, which may only be reflective of the amount of time necessary to make contact with the touch screen display and release contact such that the detector 82 can detect that a touch event has occurred.

The gesture classifier 86 may also be configured to communicate detection information regarding the recognition, detection, and/or classification of a touch event to the display manager 84. The display manager 84 may be configured to provide control over modifications made to that which is displayed on the touch screen display 68 based on the detection information received from the detector 82 and gesture classifications provided by the gesture classifier 86 in accordance with the responses prescribed for each respective gesture classification and implementation characteristic determined by the gesture classifier 86. In other words, the display manager 84 may configure the display (e.g., with respect to the content displayed and/or the user interface effects presented relative to the content displayed) according to the gesture classification and implementation characteristic classification determined for a given touch event that may be detected at the display.

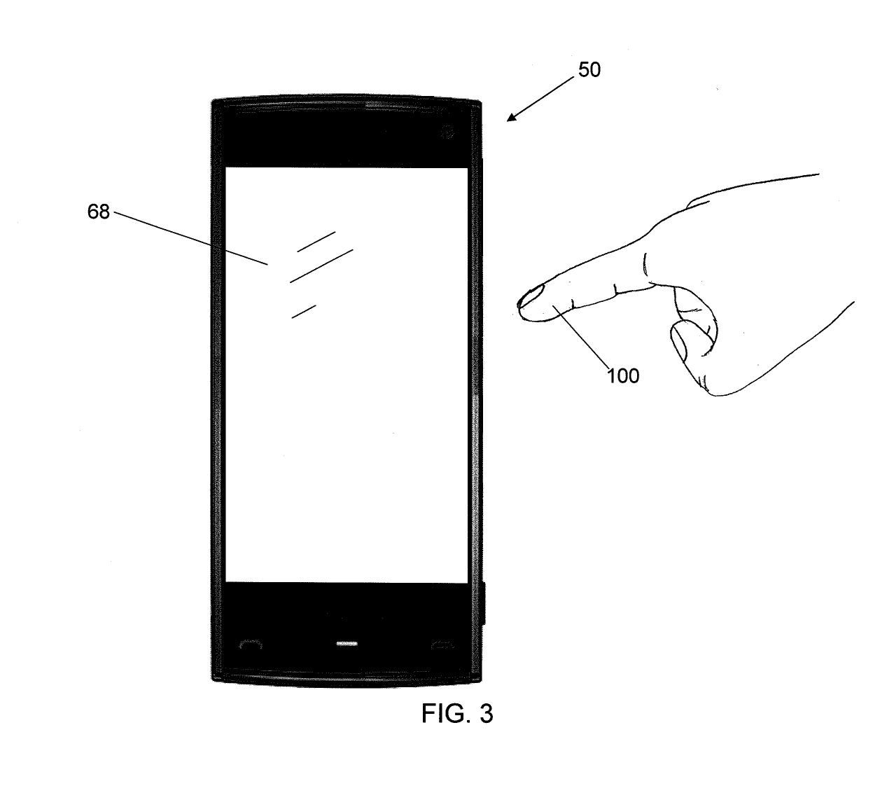

Turning now to FIG. 3, in general, an apparatus 50, such as the mobile terminal 10 of FIG. 1, is provided that has a touch screen display 68. As described above, the apparatus 50 may comprise at least one processor (e.g., processor 70 of FIG. 2) and at least one memory (e.g., memory device 76 of FIG. 2) including computer program code. The at least one memory and the computer program code may be configured to, with the processor, cause the apparatus 50 to at least receive an input (e.g., in the form of a touch event) via the touch screen display 68 of the apparatus. For example, a user may touch the touch screen display 68 with a finger 100 as part of a touch gesture to provide the input.

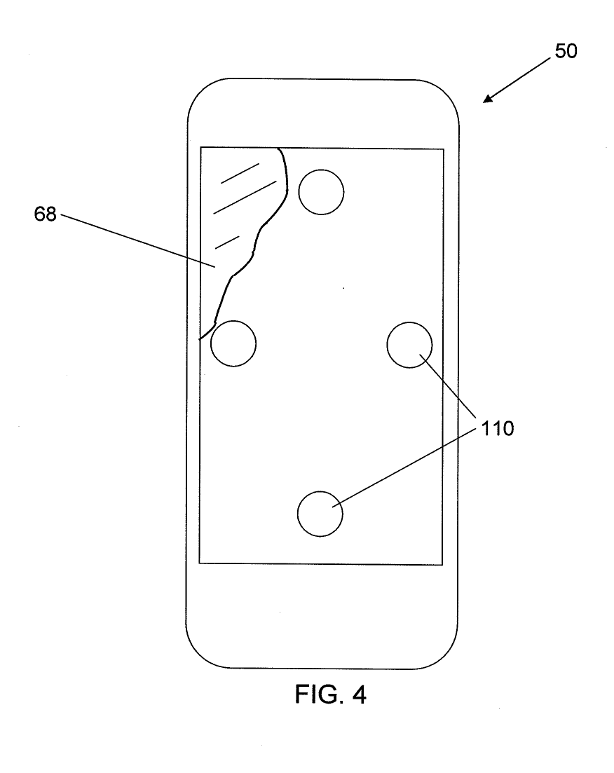

As noted above, the input may include various components that may be detected (e.g., via the detector 82 of FIG. 2) and classified (e.g., via the gesture classifier 86 of FIG. 2). In some embodiments, for example, one or more force sensors 110 may be provided beneath the touch screen display 68, as depicted in FIG. 4. The force sensors 110 may be configured to measure the force exerted by the user's touch and may thus derive a force component of the input. The apparatus 50 may in turn receive a force indication relating to the force component of the input received. The force indication may, for example, be the measured force of the input (e.g., a magnitude of the force), or the force indication may be a binary indication identifying whether force exceeding a threshold level (or one of multiple threshold levels) was received. For example, a small amount of measured force that does not exceed a first threshold may be represented as first force indication (e.g., a “level 1” force); a larger amount of measured force exceeding the first threshold but less than a second threshold may be represented as a second force indication (e.g., a “level 2” force); an even larger amount of measured force exceeding the second threshold but less than a third threshold may be represented as a third force indication (e.g., a “level 3” force); and so on.

The apparatus 50 may thus be further configured to provide for execution of an operation associated with a temporal input based on the force indication. Thus, an operation that is conventionally executed when a temporal input (e.g., an input that includes a temporal component, such as a “long press” gesture) is received may be executed instead when a force input (e.g., an input that includes a force component, such as a “hard press” gesture) is received. For example, the memory and computer program code may be configured to, with the processor, cause the apparatus to provide for execution of an operation associated with a “long press” gesture based on the force indication (e.g., an indication that the force component exceeded a certain threshold value). Conversely, the memory and computer program code may be configured to, with the processor, cause the apparatus to provide for execution of an operation associated with a “short press” gesture based on the force indication (e.g., an indication that the force component was less than a certain threshold).

In this regard, temporal inputs may be any input that has a temporal component, in which the temporal component is at least partly determinative of the operation executed. For example, a “long press” gesture, in which the user touches the touch screen display and maintains contact with the display for a certain amount of time (such as 2 seconds) may be considered a temporal input. Similarly, a “very long press” gesture, in which the user touches the touch screen display for a relatively longer period of time as compared to the “long press gesture” (e.g., 3 seconds) may also be considered a temporal input. For example, in response to a “long press” gesture, the user may be provided with several options to select from (e.g., open a message, delete a message, call a sender, respond, etc.). A “very long press” gesture in the same user application may, however, cause the execution of a default operation, such as to open a message.

A temporal input may have other components in addition to a temporal component, such as a positional component or a movement component; however, a temporal input, in contrast with other inputs, results in execution of an operation based at least in part on a time duration of the input, as described above. For example, an “acceleration” or a “speed” gesture may be a temporal input, as such a gesture includes a temporal component (e.g., implicates the time needed to traverse a defined distance). Thus, in a game application in which the user would conventionally perform an operation (such as to throw a ball fast) by moving his finger quickly across the touch screen display (thereby providing the temporal input), the user may instead increase the force applied to the touch screen display to execute the same function. Therefore, in this example, to translate between the temporal input and the force input, the applied force may be considered directly proportional or inversely proportional to time. In some embodiments, discussed below, the user may provide an input that includes both a temporal component and a force component. Thus, continuing the example above, the user may move his finger across the touch screen display with increasing speed and increasing force to indicate, for example, a “super” speed for throwing the ball.

In other words, temporal inputs typically require a user to maintain contact with the touch screen display for a predetermined amount of time (e.g., an amount of time that exceeds the nominal amount of time required for a user to contact and then release the touch screen display, such as when executing a “short press” gesture). As a result, temporal inputs necessarily impose a delay in the execution of the requested operation, as the input gesture itself requires a relatively longer amount of time to complete (e.g., as compared to a “short press” gesture). Moreover, different operations may require the user to maintain contact with the touch screen display for different amounts of time. For example, in a keyboard typing application, contact with a particular letter (e.g., the letter “e”) for two seconds may cause the apparatus to provide for the display of two of the letters (e.g., “ee”), whereas contact with the letter for three seconds may result in the display of three of the letters (e.g., “eee”). Some users may not be able to accurately gauge the length of time that contact with the touch screen display must be maintained (e.g., to type “ee”) and may, as a result, either type in too many “e”s or not enough.

By receiving a force indication relating to a force component of the input received and providing for execution of an operation associated with a temporal input based, at least in part, on the force indication, some of the problems associated with temporal inputs may be minimized. For example, inputs that include a force component, such as a “hard press” gesture, may be faster to enter (e.g., the gesture may be executed in less time) as compared to temporal inputs because they do not involve any inherent wait time. In other words, a “hard press” gesture may take 1 second to enter, which may be the same time it takes to enter a “soft press” gesture, whereas a “long press” gesture may take three times longer than a “short press” gesture (e.g., 3 seconds vs. 1 second). Furthermore, a user may be better able to gauge whether a “hard press” or a “soft press” gesture is being applied through tactile feedback through the user's fingertip (e.g., the force sensed in the fingertip as a result of the applied force to the touch screen display). Thus, providing force inputs may be more intuitive to some users as compared to providing temporal inputs, and the user may more accurately request the execution of operations by entering the appropriate input when force inputs are used.

In various embodiments of the present invention, therefore, operations associated with temporal inputs to a touch screen display are identified (e.g., by computer program code, a user interface framework, an operating system, or a combination of these), and a force input corresponding to each temporal input may be determined as described below. Each temporal input may in turn be associated with a respective corresponding force input, such that receipt of a particular force input at the touch screen display may result in the execution of an operation associated with the corresponding temporal input.

The apparatus may provide for the association between temporal inputs and force inputs (e.g., to effect execution of an operation associated with a temporal input based on the force indication) in several ways. The translation from an input having a force component to a corresponding input having a temporal component may be done, for example, by the user interface framework (e.g., via the user interface transceiver 72 of FIG. 2) and/or by the underlying operating system. In some cases, for example, the software code accessed by the processor (e.g., the processor 70 of FIG. 2) may include functional calls to operations conventionally associated with temporal inputs when certain force indications are received. Thus, the software code itself may directly map force inputs to operations associated with temporal inputs. In other cases, however, the memory and computer program code may be configured to, with the processor, cause the apparatus to determine the temporal input based, at least in part, on the force indication, and thus the temporal input may correspond to the force component of the input received. For example, the processor 70 may be configured to access a look-up table, such as a table residing on the memory device 76 or elsewhere, and the processor may thus determine which temporal input corresponds to the force component of the input actually received. In other words, the association between temporal inputs (or a temporal component of an input) and force inputs (or a force component of an input) may be made through use of the look-up table, and the processor 70 may determine the temporal input corresponding to the received force input for execution of the operation by reference to the look-up table.

In some cases, the memory and computer program code may be configured to, with the processor, cause the apparatus to determine the temporal input by determining whether the force component exceeds a predetermined threshold force value. The threshold force value may, for example, be a value that is identified in the program code. In other cases, however, the threshold force value may be configurable by the user. The user may, for example, be able to enter a value for the threshold force value (e.g., by applying a certain amount of force to the touch screen display or entering a numerical value via a keyboard), or the processor may be able to determine a value based on historical force values resulting from previous interactions of the user with the touch screen display.

In some embodiments, the memory and computer program codes may be further configured to, with the processor, cause the apparatus to determine a location of the input received on the touch screen display of the apparatus, and execution of the operation associated with the temporal input may be at least partly based on the location of the input. For example, the touch screen display 68 may be configured to detect the position of the input, e.g., by determining the x-, y-coordinates of the user's touch. This may be done using triangulation techniques. The apparatus may be configured such that an input at a particular x-, y-location and resulting in a particular force indication (e.g., if the force component of the particular input exceeds a threshold amount) would cause a particular operation typically associated with a temporal input to be executed. In other words, the underlying user interface framework may designate specific user interface elements to respond to an input having a force component by effecting execution of an operation associated with a temporal input only when a certain amount of force is applied at specific x-, y-positions on the touch screen display.

In some cases, in which multiple force sensors 110 may be provided (as depicted in FIG. 4), the force sensors may be used to detect both the position of the input and the force applied at the point of input. For example, a force gradient may be detected across the touch screen display surface by the force sensors 110, and the gradient may be used to compute the coordinates of the point at which the force was applied and the magnitude of the force.

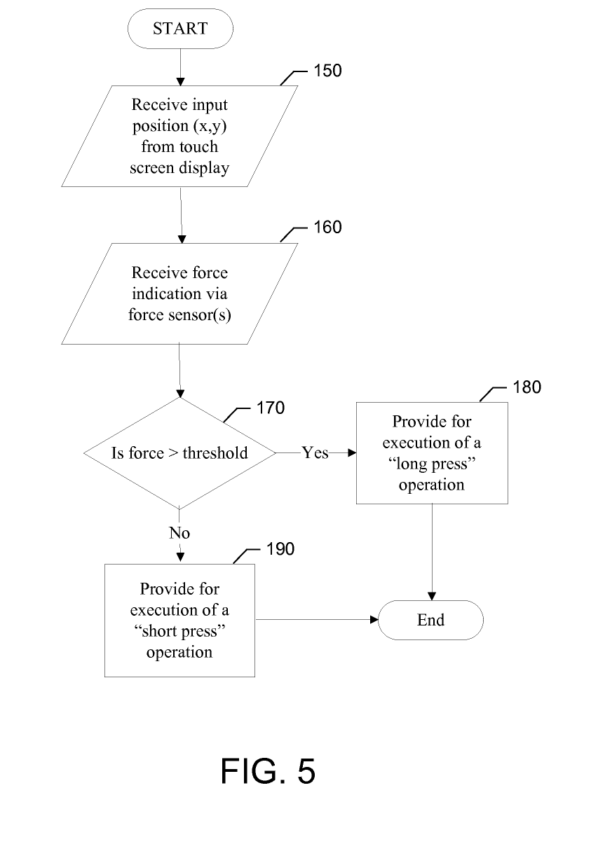

An example of a flowchart depicting the logic that may be used (on a user interface level or an operating system level) to translate force inputs to temporal inputs for effecting operations conventionally associated with temporal inputs is shown in FIG. 5. In FIG. 5, an input position may be received as described above at operation 150, and a force indication may be received based on force measurements obtained through one or more force sensors at operation 160. At operation 170, the force is compared to a threshold value of force using the force indication (or multiple force thresholds, as noted above). For example, if the force indication is a magnitude of force, the indicated magnitude is compared to one or more threshold force values. If the force indication is a binary-type indication (e.g., a “level” of force using a predetermined scale, such as 1-3), the indication is compared against a threshold indication of force. In some cases, the force applied by the user is recognized and compared with the threshold value(s) after a certain amount of time to account for the user's gradual application of force to invoke certain functions. For example, the user interface may respond to the force input only after the user has removed his finger from the display. The removal of the user's finger from the display may be detected, e.g., through the user of an additional capacitive touch sensor or by checking to see if the force level has fallen below a minimum threshold.

If the force indication reflects a force that is greater than the predetermined threshold value, the apparatus may provide for execution of an operation conventionally associated with a “long press” gesture at 180. If the force indication reflects a force that is less than the predetermined threshold value, the apparatus may provide for execution of an operation conventionally associated with a “short press” gesture at 190.

In some cases, an input (e.g., a touch gesture) may include more than one force component. For example, a user may initially apply a force to the touch screen display that exceeds a pre-determined threshold and then reduce the force below the threshold while maintaining contact with the touch screen display (e.g., in the same gesture). Considering a scenario in which the user is interacting with a map application, for example, the user may perform a panning gesture (e.g., panning from one area of the map to another by moving his finger across the touch screen display). At the same time (as part of the same gesture), the user may also wish to add a marker (e.g., a pushpin or a waypoint marker) to the map.

In this case, two force thresholds may be provided: T1 and T2, where T1 represents a greater magnitude of force than T2. When a user performs a panning gesture with a force that is less than T1, the user interface may cause the map to move with the movement of the user's finger (e.g., panning the map). When the user applies more force, such that the force of the user's touch gesture is between T1 and T2, then the map may cease moving, allowing the user's finger to move independently of the image of the map. Once the user's finger reaches a location on the map image at which the user wishes to place a marker, then the user may apply a force greater than T2. The user may then reduce the force applied to move his finger to a new location and/or to continue panning normally. In this way, the user can perform multiple operations in a continuous touch gesture without removing his finger from the touch screen display or requiring a time delay to place the marker, as would generally be the case using a conventional “long press” gesture without the addition of the force component to the input.

Furthermore, in some embodiments, the memory and computer program code may be further configured to, with the processor, cause the apparatus to receive a temporal indication relating to a temporal component of the input received and to provide for execution of the operation associated with the temporal input based on at least one of the force indication or the temporal indication. In other words, inputs may be received by the apparatus 50 (e.g., via the touch screen display) that include both a force component and a temporal component, and operations may be executed based on one or both such components. In this way, more complex inputs may be detected, classified, and acted upon, providing for enhanced functionality of the apparatus. In addition, as mentioned above, various levels of force (e.g., different force value thresholds) may be used to add another layer of granularity in the selection of an operation to be executed.

In other cases, however, one of the temporal component or the force component may trump the other, and execution of the respective operation may be based, at least in part, on the trumping component. For example, even though an input may have both a force component and a temporal component (such as a “long press” gesture that also exerts force of a certain magnitude), the temporal component may predominate, and the operation executed may be based strictly on the temporal component of the input rather than based on the force component or based on both the force and temporal components.

In some embodiments, the apparatus may be configured such that both temporal inputs and force inputs may be received, and an operation associated with the temporal input may be executed in response to both types of input. In other words, the memory and computer program code may be further configured to, with the processor, cause the apparatus to receive a first input via the touch screen display and to provide for execution of an operation based, at least in part, on a temporal component of the first input (e.g., based on the determination that the first input is a “long press” gesture). The memory and computer program code may also be configured to, with the processor, cause the apparatus to receive a second input via the touch screen display and to provide for execution of an operation based, at least in part, on a force component of the second input (e.g., based on the determination that the force component exceeds a predetermined threshold value, such as may be the case when a “hard press” gesture is received). As described above, the temporal component may be represented by a temporal indication, and the force component may be represented by a force indication, both of which may be received by the apparatus. As a result, the apparatus may be configured such that the same “long press” operation may be invoked by a “long press” gesture or a “hard press” gesture.

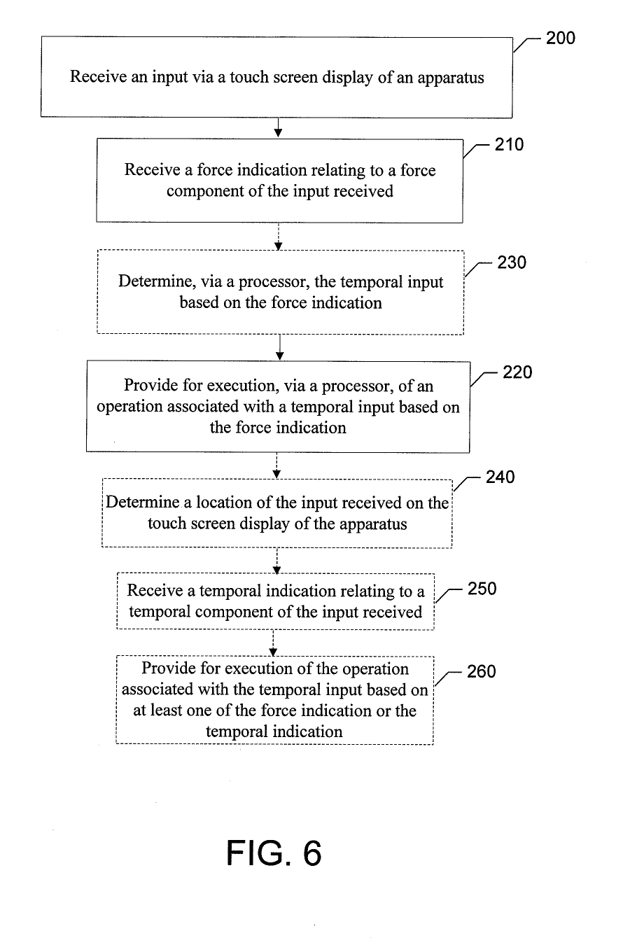

FIG. 6 illustrates a flowchart of a system, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus implements the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions, combinations of operations for performing the specified functions, and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, one embodiment of a method for translating between inputs involving force components and inputs involving temporal components to execute operations associated with temporal inputs, as shown in FIG. 5, includes receiving an input via a touch screen display of an apparatus at operation 200, receiving a force indication relating to a force component of the input received at operation 210, and providing for execution, via a processor, of an operation associated with a temporal input based, at least in part, on the force indication at operation 220. As noted above, in some cases the temporal input is determined based on the force indication prior to execution of the operation 220, such as by a processor, at operation 230. The temporal input may, for example, correspond to the force component of the input received. For example, the temporal input may be determined by evaluating whether the force component exceeds a predetermined threshold force value.

In some cases, execution of an operation associated with a “long press” gesture may be provided for based on the force indication. In other cases, execution of an operation associated with a “short press” gesture may be provided for based on the force indication. In still other cases, a location of the input received on the touch screen display of the apparatus may be determined at operation 240, and execution of the operation associated with the temporal input may be at least partly based on the location of the input, as described above. Furthermore, a temporal indication may be received that relates to a temporal component of the input received at operation 250, and the operation associated with the temporal input may be based on at least one of the force indication or the temporal indication at operation 260.

In some embodiments, certain ones of the operations above may be modified or further amplified as described below. Furthermore, in some embodiments, additional optional operations may be included, some examples of which are shown in dashed lines in FIG. 5. Modifications, additions, or amplifications to the operations above may be performed in any order and in any combination.

In an example embodiment, an apparatus for performing the method of FIG. 5 above may comprise a processor (e.g., the processor 70 of FIG. 2) configured to perform some or each of the operations (200-260) described above. The processor may, for example, be configured to perform the operations (200-260) by performing hardware implemented logical functions, executing stored instructions, or executing algorithms for performing each of the operations. Alternatively, the apparatus may comprise means for performing each of the operations described above. In this regard, according to an example embodiment, examples of means for performing at least portions of operations 200,210, and 250 may comprise, for example, the user interface transceiver 72 and/or a device or circuit for executing instructions or executing an algorithm for processing information as described above. Examples of means for performing operations 220 and 240 may comprise, for example, the processor 70, the user interface transceiver 72, and/or a device or circuit for executing instructions or executing an algorithm for processing information as described above. Moreover, examples of means for performing at least portions of operations 230 and 260 may comprise, for example, the processor 70, the user interface transceiver 72, the memory device 76, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising at least one processor and at least one memory including computer program code, the at least one memory and the computer program code configured to, with the processor, cause the apparatus to at least:
receive an input via a touch screen display of the apparatus;
receive a force indication relating to a force component of the input received; and
provide for execution of an operation associated with a temporal input based, at least in part, on the force indication.

2. The apparatus of claim 1, wherein the memory and computer program code are configured to, with the processor, cause the apparatus to determine the temporal input based, at least in part, on the force indication, wherein the temporal input corresponds to the force component of the input received.

3. The apparatus of claim 2, wherein the memory and computer program code are configured to, with the processor, cause the apparatus to determine the temporal input by determining whether the force component exceeds a predetermined threshold force value.

4. The apparatus of claim 1, wherein the memory and computer program code are configured to, with the processor, cause the apparatus to provide for execution of an operation associated with a long press gesture based, at least in part, on the force indication.

5. The apparatus of claim 1, wherein the memory and computer program code are configured to, with the processor, cause the apparatus to provide for execution of an operation associated with a short press gesture based, at least in part, on the force indication.

6. The apparatus of claim 1, wherein the memory and computer program code are further configured to, with the processor, cause the apparatus to determine a location of the input received on the touch screen display of the apparatus, wherein execution of the operation associated with the temporal input is at least partly based on the location of the input.

7. The apparatus of claim 1, wherein the memory and computer program code are further configured to, with the processor, cause the apparatus to receive a temporal indication relating to a temporal component of the input received and to provide for execution of the operation associated with the temporal input based on at least one of the force indication or the temporal indication.

8. A method comprising:
receiving an input via a touch screen display of an apparatus;
receiving a force indication relating to a force component of the input received; and
providing for execution, via a processor, of an operation associated with a temporal input based, at least in part, on the force indication.

9. The method of claim 8 further comprising determining, via a processor, the temporal input based, at least in part, on the force indication, wherein the temporal input corresponds to the force component of the input received.

10. The method of claim 9, wherein determining the temporal input comprises determining whether the force component exceeds a predetermined threshold force value.

11. The method of claim 8, wherein providing for execution of an operation associated with the temporal input comprises providing for execution of an operation associated with a long press gesture based, at least in part, on the force indication.

12. The method of claim 8, wherein providing for execution of an operation associated with the temporal input comprises providing for execution of an operation associated with a short press gesture based, at least in part, on the force indication.

13. The method of claim 8 further comprising determining a location of the input received on the touch screen display of the apparatus, wherein execution of the operation associated with the temporal input is at least partly based on the location of the input.

14. The method of claim 8 further comprising receiving a temporal indication relating to a temporal component of the input received and providing for execution of the operation associated with the temporal input based on at least one of the force indication or the temporal indication.

15. A computer program product comprising at least one computer-readable storage medium having computer-executable program code portions stored therein, the computer-executable program code portions comprising program code instructions for:
receiving an input via a touch screen display of an apparatus;
receiving a force indication relating to a force component of the input received; and
providing for execution of an operation associated with the temporal input based, at least in part, on the force indication.

16. The computer program product of claim 15 further comprising program code instructions for determining the temporal input based, at least in part, on the force indication, wherein the temporal input corresponds to the force component of the input received.

17. The computer program product of claim 16, wherein determining the temporal input comprises determining whether the force component exceeds a predetermined threshold force value.

18. The computer program product of claim 15, wherein providing for execution of an operation associated with the temporal input comprises providing for execution of an operation associated with a long press gesture based, at least in part, on the force indication.

19. The computer program product of claim 15, wherein providing for execution of an operation associated with the temporal input comprises providing for execution of an operation associated with a short press gesture based, at least in part, on the force indication.

20. The computer program product of claim 15 further comprising program code instructions for determining a location of the input received on the touch screen display of the apparatus, wherein execution of the operation associated with the temporal input is at least partly based on the location of the input.

21. The computer program product of claim 15 further comprising program code instructions for receiving a temporal indication relating to a temporal component of the input received and providing for execution of the operation associated with the temporal input based on at least one of the force indication or the temporal indication.

22. A method comprising:
identifying operations associated with temporal inputs to a touch screen display;
determine a force input corresponding to each temporal input; and
associate each temporal input with a respective corresponding force input, such that receipt of a particular force input at the touch screen display results in the execution of an operation associated with the corresponding temporal input.

23. The method of claim 22, wherein the temporal inputs and the corresponding force inputs are associated via a lookup table.

24. The method of claim 22, wherein each temporal input is associated with a respective corresponding force input via a function call.
